(19) United States
(12) Patent Application Publication
(10) Pub. No.: US 2023/0210634 A1
(43) Pub. Date: Jul. 6, 2023

(54) OUTLIER DETECTION FOR CLEAR ALIGNER TREATMENT

(71) Applicant: Align Technology, Inc., San Jose, CA (US)

(72) Inventors: Anna Akopova, Moscow (RU); Victoria Bogina, Ufa (RU); Viktoria Medvinskaya, Pushchino (RU); Roman A. Roschin, Moscow (RU); Mitra Derakhshan, Herndon, VA (US); Jeeyoung Choi, Sunnyvale, CA (US); Igor Sukhorukov, Moscow (RU); Shiva P. Sambu, Milpitas, CA (US)

(21) Appl. No.: 18/145,792

(22) Filed: Dec. 22, 2022

Related U.S. Application Data
(60) Provisional application No. 63/295,343, filed on Dec. 30, 2021.

(51) Int. Cl. A61C 7/00; A61C 13/34

(52) U.S. Cl. CPC A61C 7/002; A61C 13/34; A61C 2007/004

(57) ABSTRACT

Systems, methods, and computer-readable media for identifying and facilitating review of outlier treatment plans. A method includes receiving an initial three-dimensional (3D) model of an initial arrangement of a patient’s teeth and generating a first final 3D model of a first final arrangement of the patient’s teeth based on the initial 3D model of the initial arrangement of the patient’s teeth. The method further includes comparing the first final arrangement of the patient’s teeth with a set of a plurality of final arrangements of teeth from previous treatment plans of past patients and determining whether the first final arrangement of the patient’s teeth satisfies one or more outlier criteria based on the comparing. Responsive to determining that the first final arrangement of the patient’s teeth satisfies the one or more outlier criteria, an orthodontic treatment plan comprising the first final 3D model of the first final arrangement of the patient’s teeth is classified as a clinical risk.

### RELATED APPLICATIONS

This patent application claims the benefit under 35 U.S.C. §119(e) of U.S. Provisional Application No. 63/295,343, filed Dec. 30, 2021.

### BACKGROUND

Orthodontic treatment for a patient may include a series of aligners or other orthodontic appliances that the patient may wear throughout the treatment. The treatment may include various stages of tooth movement, with corresponding aligners that the patient may wear during each successive stage to incrementally move the patient’s teeth into a desired final arrangement.

Treatment planning, such as orthodontic treatment planning, is used to move or adapt the patient’s dentition into a desired final arrangement or physical shape of patient’s teeth. For example, in orthodontic treatment, a dental professional such as a dentist may request a desired final arrangement of a patient’s teeth and/or an automated treatment process may determine the final arrangement of the patient’s teeth. The automated treatment planning process may determine the final arrangement of the patient’s teeth based on one or more instructions received from the dental professional.

Current treatment planning processes are less than ideal for a number of reasons. For example, dental technicians may misinterpret a dentist instructions or an automated treatment planning system may produce less than ideal treatment plans. Such less than ideal treatment plans may not be discovered until review by the dental professional.

### SUMMARY

As will be described in greater detail below, the present disclosure describes various systems and methods for dental treatment planning and designing and fabricating appliances for orthodontic treatment. The present disclosure describes systems and methods for detecting less than ideal treatment plans, for example through outlier detection.

In addition, the systems and methods described herein may improve the functioning of a computing device by reducing computing resources and overhead for treatment planning, thereby improving processing efficiency of the computing device. These systems and methods may also improve the field of orthodontic and prosthodontic treatment by allowing for more accurate and safer treatment and improving the patient’s experience during treatment.

### INCORPORATION BY REFERENCE

All patents, applications, and publications referred to and identified herein are hereby incorporated by reference in their entirety, and shall be considered fully incorporated by reference even though referred to elsewhere in the application.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1A illustrates an exemplary tooth repositioning appliance or aligner that can be worn by a patient in order to achieve an incremental repositioning of individual teeth in the jaw, in accordance with some embodiments.

FIG. 1B illustrates a tooth repositioning system, in accordance with some embodiments.

FIG. 2 shows a method of orthodontic treatment using a plurality of appliances, in accordance with embodiments.

FIG. 3 shows a method for digitally planning an orthodontic treatment, in accordance with embodiments.

FIG. 4 shows a simplified block diagram of a data processing system, in accordance with embodiments.

FIG. 5 shows a method for determining a final position of a patient’s teeth, in accordance with embodiments.

FIG. 6 shows a method for training a detector of outlier treatments of a patient’s teeth, in accordance with embodiments.

FIG. 7 shows a method for detecting outlier treatment of a patient’s teeth, in accordance with embodiments.

FIG. 8 shows an example two-dimensional plot of multidimensional treatment data, in accordance with embodiments.

FIGS. 9A, 9B, and 9C shows outlier treatments identified using the outlier detection systems and methods described herein, in accordance with embodiments.

FIG. 10 shows a block diagram of an example computing system capable of implementing one or more embodiments described and/or illustrated herein, in accordance with some embodiments.

FIG. 11 shows a block diagram of an example computing network capable of implementing one or more of the embodiments described and/or illustrated herein, in accordance with some embodiments.

FIG. 12 illustrates a flowchart for an example method of identifying whether a treatment plan is an outlier from performed treatment plans based on an anticipated result of the treatment plan, in accordance with some embodiments.

FIG. 13 illustrates an intraoral scanning and treatment planning system, in accordance with an embodiment.

### DETAILED DESCRIPTION

The following detailed description provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

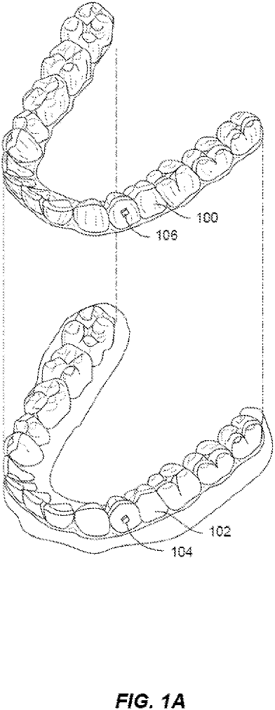

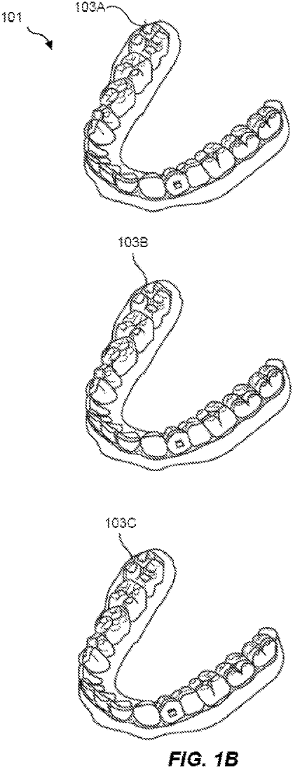

FIG. 1A illustrates an exemplary tooth repositioning appliance 100, such as an aligner that can be worn by a patient in order to achieve an incremental repositioning of individual teeth 102 in the jaw. The appliance can include a shell (e.g., a continuous polymeric shell or a segmented shell) having teeth-receiving cavities that receive and resiliently reposition the teeth. An appliance or portion(s) thereof may be indirectly fabricated using a physical model of teeth. For example, an appliance (e.g., polymeric appliance) can be formed using a physical model of teeth and a sheet of suitable layers of polymeric material. The physical model (e.g., physical mold) of teeth can be formed through a variety of techniques, including 3D printing. The appliance can be formed by thermoforming the appliance over the physical model. In some embodiments, a physical appliance is directly fabricated, e.g., using additive manufacturing techniques, from a digital model of an appliance. In some embodiments, the physical appliance may be created through a variety of direct formation techniques, such as 3D printing. An appliance can fit over all teeth present in an upper or lower jaw, or less than all of the teeth. The appliance can be designed specifically to accommodate the teeth of the patient (e.g., the topography of the tooth-receiving cavities matches the topography of the patient’s teeth) and may be fabricated based on positive or negative models of the patient’s teeth generated by impression, scanning, and the like. Alternatively, the appliance can be a generic appliance configured to receive the teeth, but not necessarily shaped to match the topography of the patient’s teeth. In some cases, only certain teeth received by an appliance will be repositioned by the appliance while other teeth can provide a base or anchor region for holding the appliance in place as it applies force against the tooth or teeth targeted for repositioning. In some cases, some or most, and even all, of the teeth will be repositioned at some point during treatment. Teeth that are moved can also serve as a base or anchor for holding the appliance as it is worn by the patient. In some embodiments, no wires or other means will be provided for holding an appliance in place over the teeth. In some cases, however, it may be desirable or necessary to provide individual attachments or other anchoring elements 104 on teeth 102 with corresponding receptacles or apertures 106 in the appliance 100 so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company’s website, which is accessible on the World Wide Web (see, e.g., the URL “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 1B illustrates a tooth repositioning system 101 including a plurality of appliances 103A, 103B. 103C. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient’s teeth can be progressively repositioned from an initial tooth arrangement to a target tooth arrangement by placing a series of incremental position adjustment appliances over the patient’s teeth. For example, the tooth repositioning system 101 can include a first appliance 103A corresponding to an initial tooth arrangement, one or more intermediate appliances 103B corresponding to one or more intermediate arrangements, and a final appliance 103C corresponding to a target arrangement. A target tooth arrangement can be a planned final tooth arrangement selected for the patient’s teeth at the end of all planned orthodontic treatment. Alternatively, a target arrangement can be one of some intermediate arrangements for the patient’s teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient’s teeth that follows one or more incremental repositioning stages. Likewise, an initial tooth arrangement can be any initial arrangement for the patient’s teeth that is followed by one or more incremental repositioning stages.

Optionally, in cases involving more complex movements or treatment plans, it may be beneficial to utilize auxiliary components (e.g., features, accessories, structures, devices, components, and the like) in conjunction with an orthodontic appliance. Examples of such accessories include but are not limited to elastics, wires, springs, bars, arch expanders, palatal expanders, twin blocks, occlusal blocks, bite ramps, mandibular advancement splints, bite plates, pontics, hooks, brackets, headgear tubes, springs, bumper tubes, palatal bars, frameworks, pin-and-tube apparatuses, buccal shields, buccinator bows, wire shields, lingual flanges and pads, lip pads or bumpers, protrusions, divots, and the like. In some embodiments, the appliances, systems and methods described herein include improved orthodontic appliances with integrally formed features that are shaped to couple to such auxiliary components, or that replace such auxiliary components.

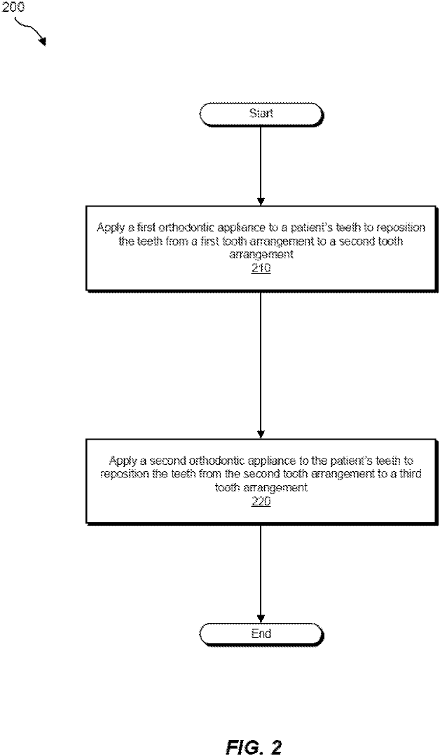

FIG. 2 illustrates a method 200 of orthodontic treatment using a plurality of appliances, in accordance with many embodiments. The method 200 can be practiced using any of the appliances or appliance sets described herein. In step 210, a first orthodontic appliance is applied to a patient’s teeth in order to reposition the teeth from a first tooth arrangement to a second tooth arrangement. In step 220, a second orthodontic appliance is applied to the patient’s teeth in order to reposition the teeth from the second tooth arrangement to a third tooth arrangement. The method 200 can be repeated as necessary using any suitable number and combination of sequential appliances in order to incrementally reposition the patient’s teeth from an initial arrangement to a target arrangement. The appliances can be generated all at the same stage or in sets or batches (e.g., at the beginning of a stage of the treatment), or one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

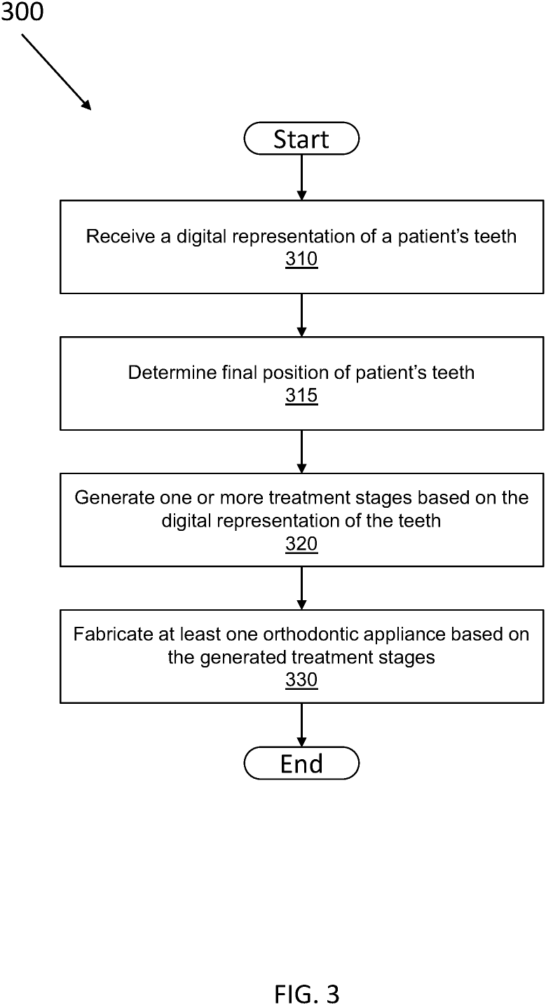

FIG. 3 illustrates a method 300 for digitally planning an orthodontic treatment and/or design or fabrication of an appliance, in accordance with many embodiments. The method 300 can be applied to any of the treatment procedures described herein and can be performed by any suitable data processing system. Any embodiment of the appliances described herein can be designed or fabricated using the method 300.

In step 310, a digital representation of a patient’s teeth is received. The digital representation can include surface topography data for the patient’s intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.). The digital representation of the patient’s teeth may be or include a virtual three-dimensional (3D) model of the patient’s upper and/or lower dental arch before treatment.

In step 315, a digital representation of a final arrangement of a patient’s teeth may be generated based on an initial digital representation of the patient’s teeth, such as the digital representation of the patient’s teeth received at step 310. The digital representation of the final arrangement of the patient’s teeth may be or include a virtual three-dimensional (3D) model of the patient’s upper and/or lower dental arch post treatment.

In step 320, one or more treatment stages are generated based on the digital representation of the teeth. The treatment stages can be incremental repositioning stages of an orthodontic treatment procedure designed to move one or more of the patient’s teeth from an initial tooth arrangement to a target four final arrangement. For example, the treatment stages can be generated by determining the initial tooth arrangement indicated by the digital representation, the determined target four final tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria. Digital representations of the arrangement of the patient’s teeth may be generated for each treatment stage. Each digital representation of the patient’s teeth for a treatment stage may be or include a virtual three-dimensional (3D) model of the patient’s upper and/or lower dental arch.

In step 330, at least one orthodontic appliance is fabricated based on the generated treatment stages. For example, a set of appliances can be fabricated to be sequentially worn by the patient to incrementally reposition the teeth from the initial arrangement to the target arrangement. Some of the appliances can be shaped to accommodate a tooth arrangement specified by one of the treatment stages. Alternatively or in combination, some of the appliances can be shaped to accommodate a tooth arrangement that is different from the target arrangement for the corresponding treatment stage. For example, as previously described herein, an appliance may have a geometry corresponding to an overcorrected tooth arrangement. Such an appliance may be used to ensure that a suitable amount of force is expressed on the teeth as they approach or attain their desired target positions for the treatment stage. As another example, an appliance can be designed in order to apply a specified force system on the teeth and may not have a geometry corresponding to any current or planned arrangement of the patient’s teeth.

In some instances, staging of various arrangements or treatment stages may not be necessary for design and/or fabrication of an appliance. Design and/or fabrication of an orthodontic appliance, and perhaps a particular orthodontic treatment, may include use of a representation of the patient’s teeth (e.g., receive a digital representation of the patient’s teeth at 310), followed by design and/or fabrication of an orthodontic appliance based on a representation of the patient’s teeth in the arrangement represented by the received representation.

A “dental consumer,” as used herein, may include a person seeking assessment, diagnosis, and/or treatment for a dental condition (general dental condition, orthodontic condition, endodontic condition, condition requiring restorative dentistry, etc.). A dental consumer may, but need not, have agreed to and/or started treatment for a dental condition. A “dental patient” (used interchangeably with patient herein) as used herein, may include a person who has agreed to diagnosis and/or treatment for a dental condition. A dental consumer and/or a dental patient, may, for instance, be interested in and/or have started orthodontic treatment, such as treatment using one or more (e.g., a sequence of) aligners (e.g., polymeric appliances having a plurality of tooth-receiving cavities shaped to successively reposition a person’s teeth from an initial arrangement toward a target arrangement).

A “dental professional” (used interchangeably with dentist, orthodontist, and doctor herein) as used herein, may include any person with specialized training in the field of dentistry, and may include, without limitation, general practice dentists, orthodontists, dental technicians, dental hygienists, etc. A dental professional may include a person who can assess, diagnose, and/or treat a dental condition. “Assessment” of a dental condition, as used herein, may include an estimation of the existence of a dental condition. An assessment of a dental condition need not be a clinical diagnosis of the dental condition. In some embodiments, an “assessment” of a dental condition may include an “image-based assessment,” that is an assessment of a dental condition based in part or on whole on photos and/or images (e.g., images that are not used to stitch a mesh or form the basis of a clinical scan) taken of the dental condition. A “diagnosis” of a dental condition, as used herein, may include a clinical identification of the nature of an illness or other problem by examination of the symptoms. “Treatment” of a dental condition, as used herein, may include prescription and/or administration of care to address the dental conditions. Examples of treatments to dental conditions include prescription and/or administration of brackets/wires, clear aligners, and/or other appliances to address orthodontic conditions, prescription and/or administration of restorative elements to address bring dentition to functional and/or aesthetic requirements, etc.

The present disclosure provides for improved orthodontic treatment and treatment planning. The methods and apparatuses described herein may improve treatment planning, as well as improve the patient’s experience during treatment. The systems and methods described herein may improve the operation of a computing device by efficiently producing clinically acceptable final arrangements for use in generating a treatment plan without requiring significantly more data or complex calculations or running additional calculations. In addition, the systems and methods provided herein may improve the field of medical care by allowing for the generation of treatment plans with less involvement from dental professionals and fewer computational resources.

In some embodiments, as described herein, treatment plans may be checked automatically to identify digital treatment plans that may involve clinical risk for the patient. The clinical risk may be caused by one or a combination of sources such as the data, algorithmic or system error in the treatment planning software or system, human errors such as those introduced by an improper prescription or an proper prescription interpreted improperly, or other factors.

In some embodiments, outlier detection may be used to identify treatment plans that may potentially involve clinical risk for the patient. In outlier detection, an initial model or function is generated based on past or previously conducted treatment plans. The initial model or function may use multiple parameters to characterize the treatment plan. In outlier detection, it is assumed that most of the treatment plans are clinically acceptable and have little clinical risk for the patient, and outliers whose parameters deviate from past treatment plans in a statistically significant manner may indicate that the treatment plan involves higher clinical risk. Accordingly, such treatment plans may be selected for further review and scrutiny by a dental professional or technician, as described herein, below.

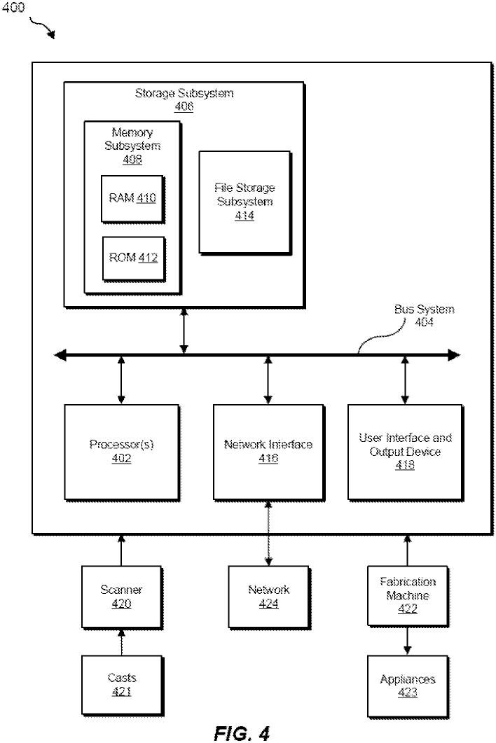

FIG. 4 is a simplified block diagram of a data processing system 400 that may be used in executing methods and processes described herein. The data processing system 400 typically includes at least one processor 402 that communicates with one or more peripheral devices via bus subsystem 404. These peripheral devices typically include a storage subsystem 406 (memory subsystem 408 and file storage subsystem 414), a set of user interface input and output devices 418, and an interface to outside networks 416. This interface is shown schematically as “Network Interface” block 416 and is coupled to corresponding interface devices in other data processing systems via communication network interface 424. Data processing system 400 can include, for example, one or more computers, such as a personal computer, workstation, mainframe, laptop, and the like.

The user interface input devices 418 are not limited to any particular device, and can typically include, for example, a keyboard, pointing device, mouse, scanner, interactive displays, touchpad, joysticks, etc. Similarly, various user interface output devices can be employed in a system of the invention, and can include, for example, one or more of a printer, display (e.g., visual, non-visual) system/subsystem, controller, projection device, audio output, and the like.

Storage subsystem 406 maintains the basic required programming, including computer readable media having instructions (e.g., operating instructions, etc.), and data constructs. The program modules discussed herein are typically stored in storage subsystem 406. Storage subsystem 406 typically includes memory subsystem 408 and file storage subsystem 414. Memory subsystem 408 typically includes a number of memories (e.g., RAM 410, ROM 412, etc.) including computer readable memory for storage of fixed instructions, instructions and data during program execution, basic input/output system, etc. File storage subsystem 414 provides persistent (non-volatile) storage for program and data files, and can include one or more removable or fixed drives or media, hard disk, floppy disk, CD-ROM, DVD, optical drives, and the like. One or more of the storage systems, drives, etc. may be located at a remote location, such coupled via a server on a network or via the internet/World Wide Web. In this context, the term “bus subsystem” is used generically so as to include any mechanism for letting the various components and subsystems communicate with each other as intended and can include a variety of suitable components/systems that would be known or recognized as suitable for use therein. It will be recognized that various components of the system can be, but need not necessarily be at the same physical location, but could be connected via various local-area or wide-area network media, transmission systems, etc.

Scanner 420 includes any means for obtaining a digital representation (e.g., images, surface topography data, etc.) of a patient’s teeth (e.g., by scanning physical models of the teeth such as casts 421, by scanning impressions taken of the teeth, or by directly scanning the intraoral cavity), which can be obtained either from the patient or from treating professional, such as an orthodontist, and includes means of providing the digital representation to data processing system 400 for further processing. Scanner 420 may be located at a location remote with respect to other components of the system and can communicate image data and/or information to data processing system 400, for example, via a network interface 424. Fabrication system or machine 422 fabricates appliances 423 based on a treatment plan, including data set information received from data processing system 400. Fabrication machine 422 can, for example, be located at a remote location and receive data set information from data processing system 400 via network interface 424.

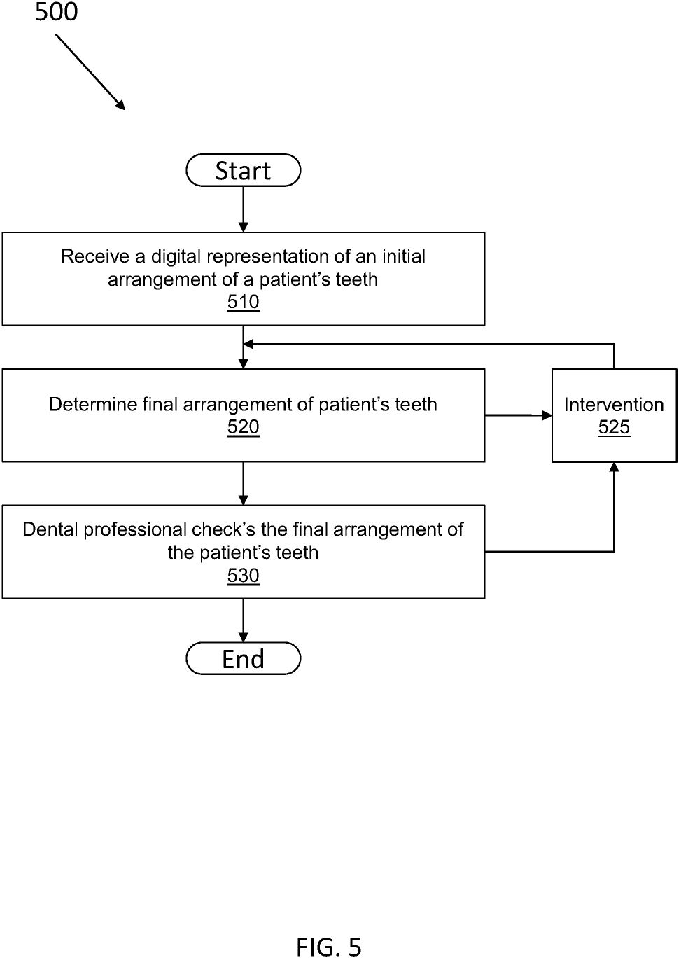

FIG. 5 shows a method 500 for determining a final position of a patient’s teeth. As illustrated in FIG. 5, at step 510 one or more of the systems described herein may receive a three-dimensional (3D) model of the initial arrangement of a patient’s dentition. For example, data processing system 400 may receive a 3D model of the patient’s dentition from directly scanning the patient’s dentition using scanner 420, or scanning casts 421 of the patient’s dentition using scanner 420. In some embodiments, the digital representation of an initial arrangement of the patient’s teeth may be the digital representation of the patient’s teeth received at step 310 of method 300.

In step 515, a digital representation of a final arrangement of a patient’s teeth may be generated based on an initial digital representation of the patient’s teeth, such as the digital representation of the patient’s teeth received at step 310. The final arrangement of the patient’s teeth may also be generated based on the dental professional’s prescription, such as are provided by the dentist. In some embodiments, the final arrangement of the patient’s teeth may include changes from a dental technician in a dental lab. In determining the final arrangement, teeth may be extracted, implanted, and/or moved, such as through translation and/or rotation. In some embodiments, an arch may be moved forward or rearward. In some embodiments, tooth material may be removed from the patient’s teeth, such as through interproximal reduction (IPR) or other means. In some embodiments, the final arrangement of teeth may be generated through an automated process, through a manual process such as by a dental technician in a dental lab, or through a combination of automated and manual processes.

In step 520, the final position of the patient’s tooth is analyzed to determine whether the treatment plan may include high clinical risk and/or have an improper or unreasonable setup. If it is determined that the treatment plan may have a high clinical risk, the process proceeds to step 525. In some embodiments, high clinical risk, improper setups, and/or unreasonable setups may not be detectable using rules alone. Final tooth arrangements may have hundreds of parameters to evaluate that may have second, third or higher order interactions. Accordingly, outlier detection functions may be used to evaluate whether a treatment plan may include high clinical risk, and/or include an improper and/or unreasonable setup.

Outlier detection may be performed using a local outlier factor method (e.g., such as the cluster-based local outlier factor method), a nearest neighbor outlier detection method (e.g., such as a k-nearest neighbor algorithm, a tree-based algorithm, such as an isolation forest), or other outlier detection method. The cluster-based local outlier factor method may consider a data point’s location with respect to its nearest neighbors and the associated local density of data points in order to determine whether or not a data point is an outlier. A k-nearest neighbor algorithm considers the distance a data point is from the K nearest points in the data set where K is an integer number. The isolation forest algorithm may use anomaly detection to determine outliers. In an isolation forest algorithm, binary trees are created and then a new data point may be traversed through all the trees and an anomaly or outlier store may be assigned to the data points based on the depth of the data points traversal of each of the trees.

Each of these outlier detection methods may use parameters to determine whether a data point, such as a final arrangement of a patient’s teeth, is an outlier. The patient’s dentition may have hundreds of parameters. For example, each tooth may have one or more parameters including inclination, inclination-by-axes, rotation, rotation-by-axes, angulation, angulation-by-axis, prominence, whether a tooth is extracted or missing, the space between adjacent teeth, and other parameters. Inclination and rotation and their “by-axes” airports may be based on different coordinate systems or measurements. For example, inclination and rotation may be based on the inclination rotation of the lingual surface of the tooth while “by-axis” counterparts may be determined based on the long axis of the tooth.

At step 525, automated or manual intervention may be performed on the digital representation of the final arrangement of the patient’s teeth. The intervention may include reviewing and correcting the final position of the patient’s teeth. In some embodiments, the intervention may include reviewing and correcting the teeth for excess tooth material removal, misplaced teeth, improperly arranged teeth, high collision depth between adjacent teeth or between teeth of opposing arches when the arches are in occlusion with each other, spaces or gaps between teeth, by tooth intrusion or extrusion, or other less than desirable tooth arrangements or tooth treatments. After the intervention, the revised final position may be passed back to step 520 subsequent evaluation.

After the process 520 determines, by analyzing the final arrangement of the patient’s teeth, that the treatment plan may be proper or have low clinical risk, the treatment plan may be sent to a dental professional for further review. If the treatment plan passes the dental professional’s review, the final arrangement may be used to generate the treatment stages at step 320, and/or to fabricate dental appliances at step 330 of method 300.

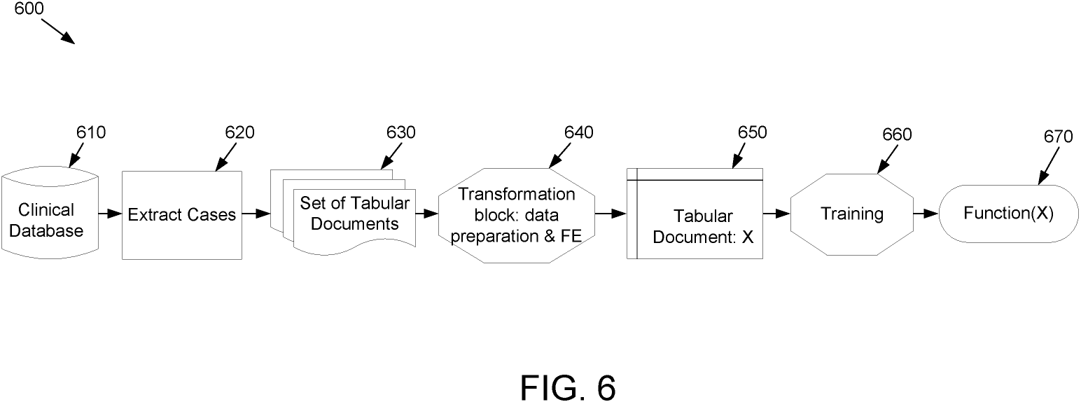

FIG. 6 shows a method and data flow 600 for training a detector of outlier treatments of a patient’s teeth. At step 620, previous treatment plans may be extracted from the clinical database 610 containing previous treatment plans. The cases may be extracted to build models based on different features. For example, cases may be extracted based on geographic region, age group, and/or date range. In some embodiments, different geographic regions, age groups, and/or dates of treatment may have different characteristics. Accordingly, the process 600 may be carried out multiple times in order to generate models for each rotation of geographic region age group, and relevant data treatment. In some embodiments, the data treatment may be restricted to more current dates in order to capture the newest and most advanced treatment procedures while the older treatments may be ignored.

At step 630, the data in the extracted cases is tabularized into a set of one or more documents. Tabularizing the data may include generating the data in a format that may be received by the outlier algorithms and/or the transformation algorithms.

At step 640, the tabular data is transformed. In some embodiments, data may be transformed in order to put it in common units. In some embodiments, the data may be transformed by normalizing or otherwise scaling the data. In some embodiments, the tabular data may be subject to principal component analysis in order to dimensionally reduce the data and/or to otherwise determine the principal components of the parameters in the data in order to reduce the computational burden of training the system and developing the objects.

At step 650, the tabular document may be generated based on the transformed data. The tabular document may include the parameters for each data point such as the parameters for each of the past treatment plans formatted in a manner for inputting into the training algorithm. In some embodiments, one or more of the steps 630, 640, and 650 may be carried out to prepare data for each outlier function.

At step 660, the outlier model is trained. For a cluster-based local outlier factor, the training data is run through a cluster-based local outlier algorithm to determine the location of each data point and generate multidimensional clusters based on the parameters of the extracted cases from the clinical database. For an average k-nearest neighbors (k-NN) algorithm, the training phase includes sorting feature vectors and class labels based on the parameters of the extracted cases from the database. In an isolation forest algorithm, binary trees are created for each of the parameters based on the parameters of the extracted cases from a clinical database.

At step 670, the trained outlier function is generated based on the output of the training in step 660.

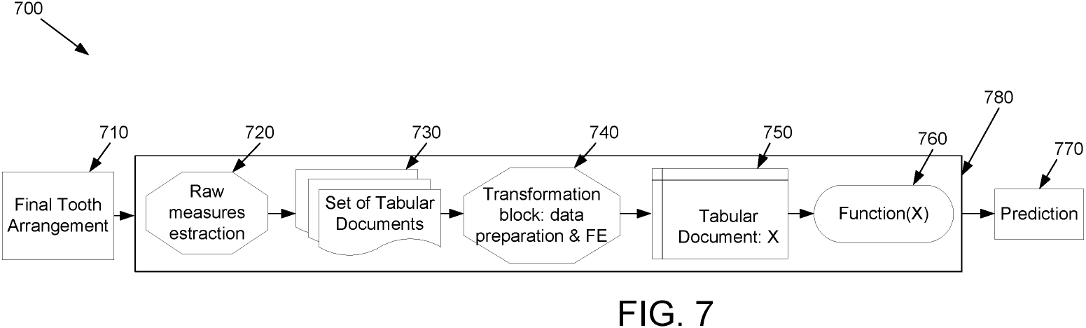

FIG. 7 shows a method 700 for detecting outlier treatment of a patient’s teeth. The method 700 may be carried out in block 520 of method 500. At step 710, a digital representation of a final tooth arrangement is received. The digital representation of the final tooth arrangement may be generated as described above with respect to, for example, FIGS. 3 and 5. The digital representation of the final tooth arrangement may be a three-dimensional model of the patient’s teeth in the final arrangement.

At step 720, the raw measurements are extracted from the final tooth arrangement. In some embodiments, the measurement extraction may also include generating the parameters of the final tooth arrangement such as inclination, inclination-by-axes, rotation, rotation-by-axes, prominence, whether a tooth is extracted or missing, the space between adjacent teeth, and/or other parameters for each of the patient’s teeth in the final tooth arrangement.

At step 730, the data generated at step 720 from the final tooth arrangement is tabularized into a set of one or more documents. Tabularizing the data may include generating the data in a format that may be received by the outlier algorithms and/or the transformation algorithms.

At step 740, the tabular data is transformed. In some embodiments, data may be transformed in order to put it in common units. In some embodiments, the data may be transformed by normalizing or otherwise scaling the data. In some embodiments, the tabular data may be subject to principal component analysis in order to dimensionally reduce the data to otherwise determine the principal components of the parameters in the data in order to reduce the computational burden of training the system and developing the objects.

At step 750, a tabular document may be generated based on the transformed data. The tabular document may include the parameters for each data point such as the parameters for each of the past treatment plans formatted in a manner for inputting into the training algorithm. In some embodiments, each of steps 730, 740, and 750 may be carried out for each outlier function that the data may be run through.

At step 760, the data within the tabular document is run through one or more outlier functions to determine whether or not the treatment plan is outlier. In some embodiments, the outlier functions are or include one or more trained machine learning models. For a cluster-based local outlier factor, the tabular data is run through a cluster-based local outlier algorithm to determine the location of data point with respect to the multidimensional clusters generated during the training phase base of the parameters of the final tooth arrangement. For an average k-NN algorithm the function generates the feature vectors in classes based on the parameters of the final tooth arrangement. In an isolation forest algorithm, each parameter of the tabular data run through each respective binary tree is located in the correct position on each respective binary tree.

At step 770, a prediction as to whether the treatment plan is an outlier is determined based on the results of the one or more outlier detection models. In some embodiments, multiple outlier detection models are run and a prediction as to whether or not a treatment plan is an outlier is based on whether or not a majority or super majority of the outlier detection models determined that the treatment plan is an outlier. If it is determined that the treatment plan is an outlier, then intervention may occur. Intervention may include a review of the treatment plan, and if appropriate, correction of the treatment plan, for example as described with respect to FIG. 5.

Each of the outlier detection models may generate an output. Each of the outputs may be compared to one or more outlier detection criteria. Different outlier detection criteria may be used for different outlier detection models. Examples of outlier detection criteria include a threshold deviation, a local outlier factor threshold, an average k-NN threshold, a path length threshold, and so on. The different outlier detection models and their associated outlier detection criteria are set forth in greater detail below. Based on a result of the comparison of the output(s) to the one or more outlier detection criteria, processing logic may determine whether one or more of the outlier detection criteria are satisfied. If one or more of the outlier detection criteria are satisfied (e.g., if a threshold amount such more than one or a majority of the outlier detection criteria are satisfied), then processing logic may determine that a treatment plan (e.g., an orthodontic treatment plan) comprising a 3D model of the final arrangement of the patient’s teeth is a clinical risk. In such cases, the treatment plan may be flagged for manual inspection or may be automatically modified. A technician or other practitioner may inspect a flagged treatment plan to confirm whether a first final arrangement of the patient’s teeth associated with the treatment plan is problematic (e.g., poses a clinical risk). If the first final arrangement of the patient’s teeth is determined to be problematic, then a new treatment plan having a second final arrangement of the patient’s teeth may be generated. The above described assessment process may then be performed for the newly generated treatment plan.

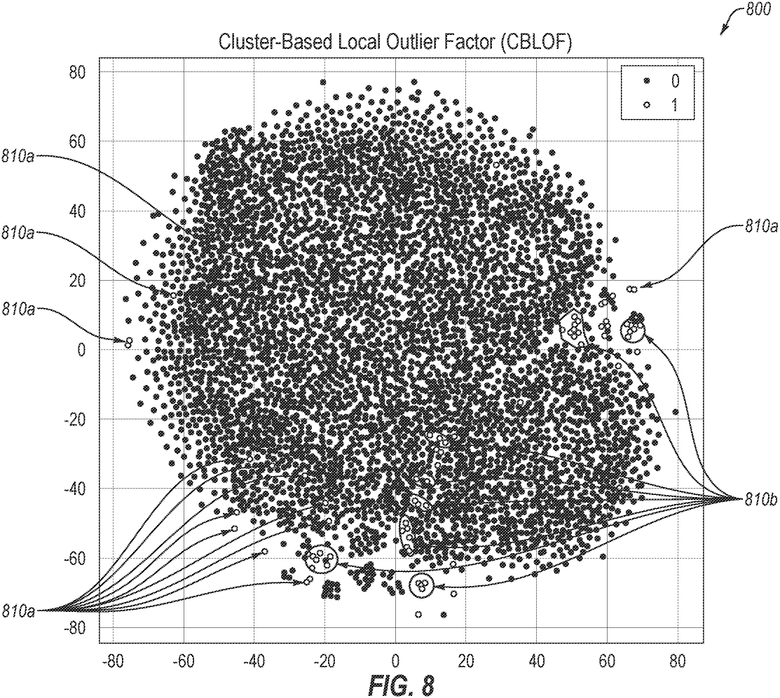

FIG. 8 shows an example two-dimensional plot of multidimensional treatment data based on prior treatment plans. The two-dimensional plot is a simplification of the multidimensional data that is easier for humans to understand. The two-dimensional plot is generated from prior treatment plans run through a cluster-based local outlier factor algorithm. The plot 800 includes outlier data points 810a and 810b plotted amongst nonoutlier data points. In some embodiments, some treatment plans are shown to be individual outlier data points such as outlier data points 810a. In some embodiments, outlier treatment plans may be located near each other in the two-dimensional plot, such as the groups of outlier data points 810b.

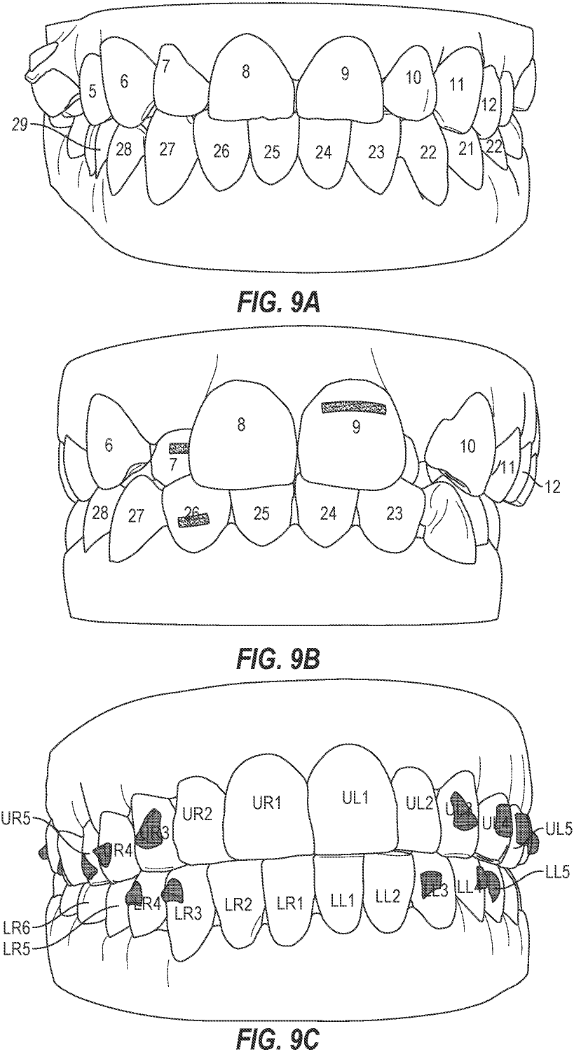

FIGS. 9A, 9B, and 9C show outlier treatments identified using the outlier detection systems and methods described herein, in accordance with embodiments. Each of these three treatments show examples of less than ideal treatment plans. For example, in FIG. 9A, the midline of the upper and lower arch is not aligned. Additionally, the bicuspid, tooth 4, is rotated in an undesirable orientation. In FIG. 9B, the midlines of the upper and lower arch do not align, the posterior teeth of the upper arch are shifted with respect to the posterior teeth of the lower arch, and large gaps or spaces exist between the upper central incisors and their adjacent teeth. In some embodiments, FIG. 9B may be an example of a treatment plan that was identified as an outlier that may be a clinically acceptable treatment plan because the patient is missing several teeth and this final arrangement may be clinically acceptable based on the number and type of teeth remaining. In FIG. 9C, the midlines appear to be appropriately aligned and the teeth appear to be in the appropriate positions. However, there may be collisions between the teeth. For example, the upper central incisors may be located in final positions that are impossible to achieve because the teeth are interfering with each other or occupying the same space.

### Computing System

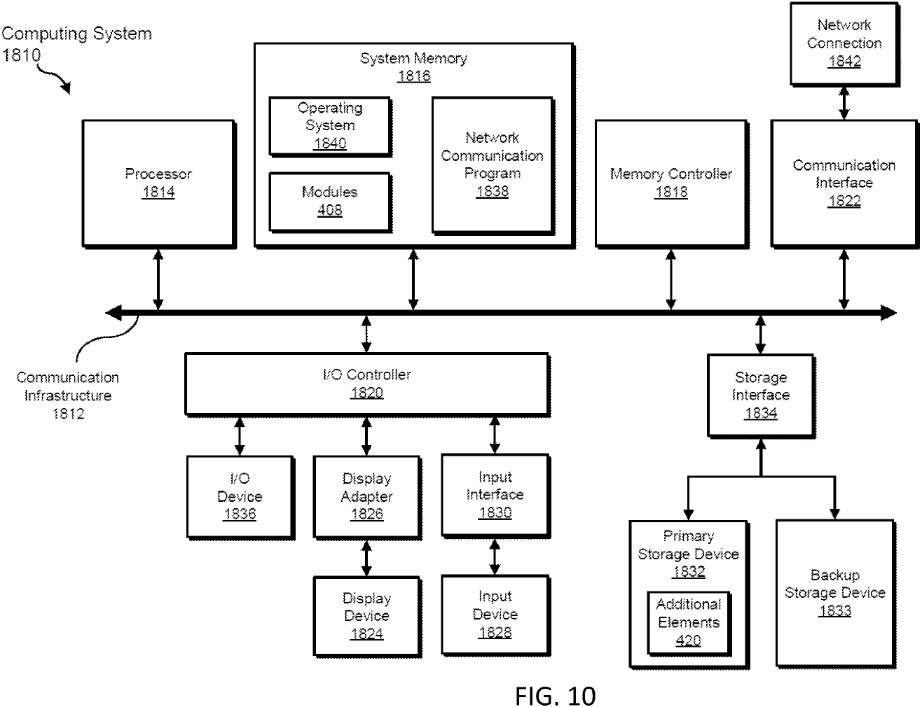

FIG. 10 is a block diagram of an example computing system 1810 capable of implementing one or more of the embodiments described and/or illustrated herein. For example, all or a portion of computing system 1810 may perform and/or be a means for performing, either alone or in combination with other elements, one or more of the steps described herein (such as one or more of the steps illustrated in FIGS. 2, 3, 5, 6, and 7). All or a portion of computing system 1810 may also perform and/or be a means for performing any other steps, methods, or processes described and/or illustrated herein.

Computing system 1810 broadly represents any single or multi-processor computing device or system capable of executing computer-readable instructions. Examples of computing system 1810 include, without limitation, workstations, laptops, client-side terminals, servers, distributed computing systems, handheld devices, or any other computing system or device. In its most basic configuration, computing system 1810 may include at least one processor 1814 and a system memory 1816.

Processor 1814 generally represents any type or form of physical processing unit (e.g., a hardware-implemented central processing unit) capable of processing data or interpreting and executing instructions. In certain embodiments, processor 1814 may receive instructions from a software application or module. These instructions may cause processor 1814 to perform the functions of one or more of the example embodiments described and/or illustrated herein.

System memory 1816 generally represents any type or form of volatile or non-volatile storage device or medium capable of storing data and/or other computer-readable instructions. Examples of system memory 1816 include, without limitation, Random Access Memory (RAM), Read Only Memory (ROM), flash memory, or any other suitable memory device. Although not required, in certain embodiments computing system 1810 may include both a volatile memory unit (such as, for example, system memory 1816) and a non-volatile storage device (such as, for example, primary storage device 1832, as described in detail below). In one example, one or more of the software components in FIG. 16 may be loaded into system memory 1816.

In some examples, system memory 1816 may store and/or load an operating system 1840 for execution by processor 1814. In one example, operating system 1840 may include and/or represent software that manages computer hardware and software resources and/or provides common services to computer programs and/or applications on computing system 1810. Examples of operating system 1840 include, without limitation, LINUX, JUNOS, MICROSOFT WINDOWS, WINDOWS MOBILE, MAC OS, APPLE’S IOS, UNIX, GOOGLE CHROME OS, GOOGLE’S ANDROID, SOLARIS, variations of one or more of the same, and/or any other suitable operating system.

In certain embodiments, example computing system 1810 may also include one or more components or elements in addition to processor 1814 and system memory 1816. For example, as illustrated in FIG. 10, computing system 1810 may include a memory controller 1818, an Input/Output (I/O) controller 1820, and a communication interface 1822, each of which may be interconnected via a communication infrastructure 1812. Communication infrastructure 1812 generally represents any type or form of infrastructure capable of facilitating communication between one or more components of a computing device. Examples of communication infrastructure 1812 include, without limitation, a communication bus (such as an Industry Standard Architecture (ISA), Peripheral Component Interconnect (PCI), PCI Express (PCIe), or similar bus) and a network.

Memory controller 1818 generally represents any type or form of device capable of handling memory or data or controlling communication between one or more components of computing system 1810. For example, in certain embodiments memory controller 1818 may control communication between processor 1814, system memory 1816, and I/O controller 1820 via communication infrastructure 1812.

I/O controller 1820 generally represents any type or form of module capable of coordinating and/or controlling the input and output functions of a computing device. For example, in certain embodiments I/O controller 1820 may control or facilitate transfer of data between one or more elements of computing system 1810, such as processor 1814, system memory 1816, communication interface 1822, display adapter 1826, input interface 1830, and storage interface 1834.

As illustrated in FIG. 10, computing system 1810 may also include at least one display device 1824 coupled to I/O controller 1820 via a display adapter 1826. Display device 1824 generally represents any type or form of device capable of visually displaying information forwarded by display adapter 1826. Similarly, display adapter 1826 generally represents any type or form of device configured to forward graphics, text, and other data from communication infrastructure 1812 (or from a frame buffer, as known in the art) for display on display device 1824.

As illustrated in FIG. 10, example computing system 1810 may also include at least one input device 1828 coupled to I/O controller 1820 via an input interface 1830. Input device 1828 generally represents any type or form of input device capable of providing input, either computer or human generated, to example computing system 1810. Examples of input device 1828 include, without limitation, a keyboard, a pointing device, a speech recognition device, variations or combinations of one or more of the same, and/or any other input device.

Additionally or alternatively, example computing system 1810 may include additional I/O devices. For example, example computing system 1810 may include I/O device 1836. In this example, I/O device 1836 may include and/or represent a user interface that facilitates human interaction with computing system 1810. Examples of I/O device 1836 include, without limitation, a computer mouse, a keyboard, a monitor, a printer, a modem, a camera, a scanner, a microphone, a touchscreen device, variations or combinations of one or more of the same, and/or any other I/O device.

Communication interface 1822 broadly represents any type or form of communication device or adapter capable of facilitating communication between example computing system 1810 and one or more additional devices. For example, in certain embodiments communication interface 1822 may facilitate communication between computing system 1810 and a private or public network including additional computing systems. Examples of communication interface 1822 include, without limitation, a wired network interface (such as a network interface card), a wireless network interface (such as a wireless network interface card), a modem, and any other suitable interface. In at least one embodiment, communication interface 1822 may provide a direct connection to a remote server via a direct link to a network, such as the Internet. Communication interface 1822 may also indirectly provide such a connection through, for example, a local area network (such as an Ethernet network), a personal area network, a telephone or cable network, a cellular telephone connection, a satellite data connection, or any other suitable connection.

In certain embodiments, communication interface 1822 may also represent a host adapter configured to facilitate communication between computing system 1810 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 1822 may also allow computing system 1810 to engage in distributed or remote computing. For example, communication interface 1822 may receive instructions from a remote device or send instructions to a remote device for execution.

In some examples, system memory 1816 may store and/or load a network communication program 1838 for execution by processor 1814. In one example, network communication program 1838 may include and/or represent software that enables computing system 1810 to establish a network connection 1842 with another computing system (not illustrated in FIG. 10) and/or communicate with the other computing system by way of communication interface 1822. In this example, network communication program 1838 may direct the flow of outgoing traffic that is sent to the other computing system via network connection 1842. Additionally or alternatively, network communication program 1838 may direct the processing of incoming traffic that is received from the other computing system via network connection 1842 in connection with processor 1814.

Although not illustrated in this way in FIG. 10, network communication program 1838 may alternatively be stored and/or loaded in communication interface 1822. For example, network communication program 1838 may include and/or represent at least a portion of software and/or firmware that is executed by a processor and/or Application Specific Integrated Circuit (ASIC) incorporated in communication interface 1822.

As illustrated in FIG. 10, example computing system 1810 may also include a primary storage device 1832 and a backup storage device 1833 coupled to communication infrastructure 1812 via a storage interface 1834. Storage devices 1832 and 1833 generally represent any type or form of storage device or medium capable of storing data and/or other computer-readable instructions. For example, storage devices 1832 and 1833 may be a magnetic disk drive (e.g., a so-called hard drive), a solid state drive, a floppy disk drive, a magnetic tape drive, an optical disk drive, a flash drive, or the like. Storage interface 1834 generally represents any type or form of interface or device for transferring data between storage devices 1832 and 1833 and other components of computing system 1810. In one example, one or more of the software components in FIG. 16 may be stored and/or loaded in primary storage device 1832.

In certain embodiments, storage devices 1832 and 1833 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 1832 and 1833 may also include other similar structures or devices for allowing computer software, data, or other computer-readable instructions to be loaded into computing system 1810. For example, storage devices 1832 and 1833 may be configured to read and write software, data, or other computer-readable information. Storage devices 1832 and 1833 may also be a part of computing system 1810 or may be a separate device accessed through other interface systems.

Many other devices or subsystems may be connected to computing system 1810. Conversely, all of the components and devices illustrated in FIG. 10 need not be present to practice the embodiments described and/or illustrated herein. The devices and subsystems referenced above may also be interconnected in different ways from that shown in FIG. 10. Computing system 1810 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 1810. All or a portion of the computer program stored on the computer-readable medium may then be stored in system memory 1816 and/or various portions of storage devices 1832 and 1833. When executed by processor 1814, a computer program loaded into computing system 1810 may cause processor 1814 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 1810 may be configured as an Application Specific Integrated Circuit (ASIC) adapted to implement one or more of the example embodiments disclosed herein.

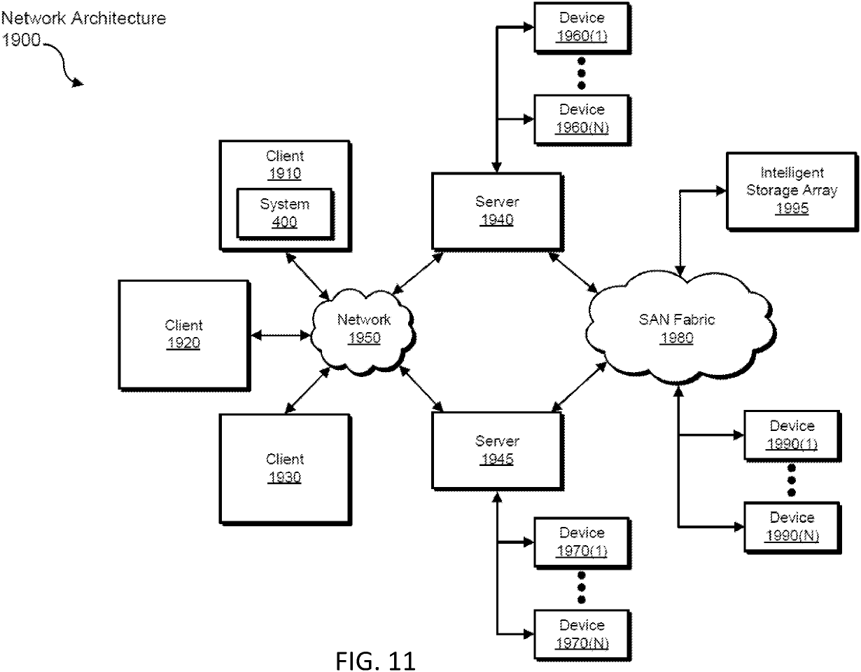

FIG. 11 is a block diagram of an example network architecture 1900 in which client systems 1910, 1920, and 1930 and servers 1940 and 1945 may be coupled to a network 1950. As detailed above, all or a portion of network architecture 1900 may perform and/or be a means for performing, either alone or in combination with other elements, one or more of the steps disclosed herein (such as one or more of the steps illustrated in FIGS. 2, 3, 5, 15, and 17). All or a portion of network architecture 1900 may also be used to perform and/or be a means for performing other steps and features set forth in the instant disclosure.

Client systems 1910, 1920, and 1930 generally represent any type or form of computing device or system, such as example computing system 1810 in FIG. 10. Similarly, servers 1940 and 1945 generally represent computing devices or systems, such as application servers or database servers, configured to provide various database services and/or run certain software applications. Network 1950 generally represents any telecommunication or computer network including, for example, an intranet, a WAN, a LAN, a PAN, or the Internet. In one example, client systems 1910, 1920, and/or 1930 and/or servers 1940 and/or 1945 may include all or a portion of the systems described in FIG. 4.

As illustrated in FIG. 11, one or more storage devices 1960(1)-(N) may be directly attached to server 1940. Similarly, one or more storage devices 1970(1)-(N) may be directly attached to server 1945. Storage devices 1960(1)-(N) and storage devices 1970(1)-(N) generally represent any type or form of storage device or medium capable of storing data and/or other computer-readable instructions. In certain embodiments, storage devices 1960(1)-(N) and storage devices 1970(1)-(N) may represent Network-Attached Storage (NAS) devices configured to communicate with servers 1940 and 1945 using various protocols, such as Network File System (NFS), Server Message Block (SMB), or Common Internet File System (CIFS).

Servers 1940 and 1945 may also be connected to a Storage Area Network (SAN) fabric 1980. SAN fabric 1980 generally represents any type or form of computer network or architecture capable of facilitating communication between a plurality of storage devices. SAN fabric 1980 may facilitate communication between servers 1940 and 1945 and a plurality of storage devices 1990(1)-(N) and/or an intelligent storage array 1995. SAN fabric 1980 may also facilitate, via network 1950 and servers 1940 and 1945, communication between client systems 1910, 1920, and 1930 and storage devices 1990(1)-(N) and/or intelligent storage array 1995 in such a manner that devices 1990(1)-(N) and array 1995 appear as locally attached devices to client systems 1910, 1920, and 1930. As with storage devices 1960(1)-(N) and storage devices 1970(1)-(N), storage devices 1990(1)-(N) and intelligent storage array 1995 generally represent any type or form of storage device or medium capable of storing data and/or other computer-readable instructions.

In certain embodiments, and with reference to example computing system 1810 of FIG. 10, a communication interface, such as communication interface 1822 in FIG. 10, may be used to provide connectivity between each client system 1910, 1920, and 1930 and network 1950. Client systems 1910, 1920, and 1930 may be able to access information on server 1940 or 1945 using, for example, a web browser or other client software. Such software may allow client systems 1910, 1920, and 1930 to access data hosted by server 1940, server 1945, storage devices 1960(1)-(N), storage devices 1970(1)-(N), storage devices 1990(1)-(N), or intelligent storage array 1995. Although FIG. 11 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 1940, server 1945, storage devices 1960(1)-(N), storage devices 1970(1)- (N), storage devices 1990(1)-(N), intelligent storage array 1995, or any combination thereof. All or a portion of one or more of the example embodiments disclosed herein may also be encoded as a computer program, stored in server 1940, run by server 1945, and distributed to client systems 1910, 1920, and 1930 over network 1950.

As detailed above, computing system 1810 and/or one or more components of network architecture 1900 may perform and/or be a means for performing, either alone or in combination with other elements, one or more steps of an example method for virtual care.

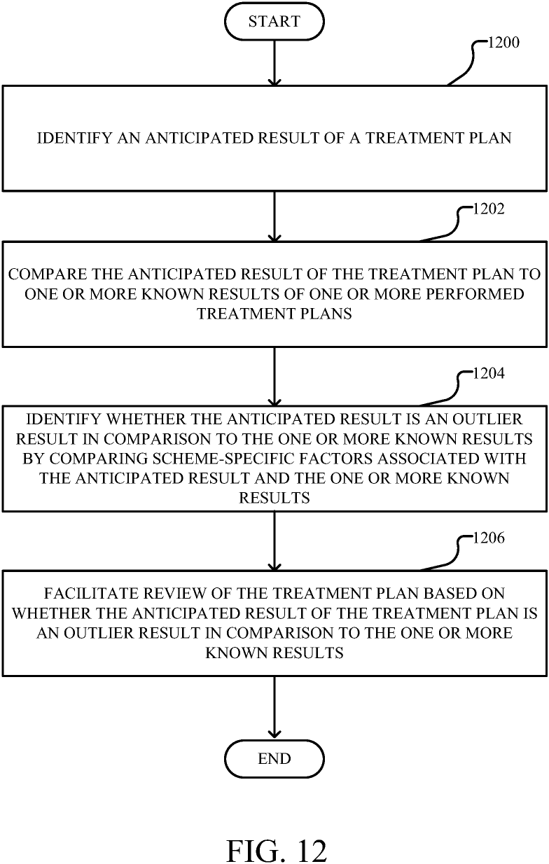

FIG. 12 illustrates a flowchart for an example method of identifying whether a treatment plan is an outlier from performed treatment plans based on an anticipated result of the treatment plan. The method shown in FIG. 12 is provided by way of example, as there are a variety of ways to carry out the method. Additionally, while the example method is illustrated with a particular order of steps, those of ordinary skill in the art will appreciate that FIG. 12 and the blocks shown therein can be executed in any order and can include fewer or more modules than illustrated. Each block shown in FIG. 12 represents one or more steps, processes, methods and/or routines in the method.

At step 1200, an anticipated result of a treatment plan is identified. A treatment plan, as used herein, can include an applicable program of action in which a specific result is desired through implementation of the treatment plan. In particular, a treatment plan can include a digital treatment plan for achieving a desired treatment result in a patient. A treatment plan can be defined by a plurality of different operations that are performed in carrying out the treatment plan to achieve a specific result. For example, a treatment plan can include a schedule for applying different appliances to a patient to reposition teeth of the patient to achieve a desired result. Further in the example, the treatment plan can specify characteristics of the different appliances that are used to achieve the desired result.

The anticipated result of the treatment plan is identified at step 1200 before all of the treatment plan is performed. Specifically, the anticipated result of the treatment plan can be simulated before the treatment plan is performed in its entirety. For example, the anticipated result can be a simulated representation of teeth positions resulting from application of an orthodontic treatment plan. Further in the example, the simulated representation can include a 3D representation of the teeth positions.

At step 1202, the anticipated result of the treatment plan is compared to one or more known results of one or more performed treatment plans. The performed treatment plans can be related treatment plans to the treatment plan for which the results are anticipated at step 1200. Specifically, the performed treatment plans can be the same type of treatment plan as the treatment plan of the anticipated result. For example, the performed treatment plans and the treatment plan can be the same type of orthodontic treatment plan.

At step 1204, it is identified whether the anticipated result is an outlier result. Specifically, at step 1204, it is identified whether the anticipated result is an outlier result in comparison to the one or more known results. An outlier, as used herein, can include a result of a treatment plan, such as an orthodontic treatment plan, that deviates from results of standard, typical, or otherwise accepted treatment plans by one or more certain degrees of deviation. Such degrees of deviation can be expressed through one or more quantified amounts that represent differences in factors associated with the treatment plans. Further, such degrees of deviation can be described in relation to one or more thresholds that define the certain degrees that qualify a treatment plan as an outlier.

The anticipated result can be identified as an outlier result based on a comparison of treatment plan-specific factors associated with the anticipated result and treatment plan-specific factors associated with the one or more known results. Treatment plan-specific factors associated with results, as used herein, include factors in the results that are ultimately affected by variables in a treatment plan that are or will be applied to achieve the results. For example, treatment plan-specific factors can include a factor that application of appliances of a certain shape will achieve specific tooth displacement through application of the appliances.

Treatment plan-specific factors associated with results can include characteristics that are actually seen or achieved in results, be it actual results or simulated results. Further, treatment plan-specific factors associated with results can include features in differences between characteristics of results. For example, treatment plan-specific factors associated with results can indicate that there is a two degree difference in tooth position between known results and anticipated results of orthodontic treatment plans.

One or more machine learning outlier detection techniques can be applied in determining whether the result is an outlier. This is advantageous as a human mind is often incapable of analyzing all of the treatment plan-specific factors that define an overall result of a treatment plan. In particular and in the field of treatment plan review, a large number of treatment plan-specific factors define the results, making it difficult for a human to conceptualize and properly analyze the results. More specifically, such large number of treatment plan-specific factors in results can be difficult for a human to quantify or qualify when comparing the results, e.g. for purposes of analyzing a treatment plan.

At step 1206, review of the treatment plan is facilitated based on whether the anticipated result of the treatment plan is an outlier result in comparison to the one or more known results. Specifically, if the treatment plan is identified as an outlier based on the anticipated result, then review of the treatment plan can be facilitated. In facilitating review of the treatment plan, the treatment plan can be flagged for actual review by a human. Further, in facilitating review of the treatment plan, the treatment plan can be changed, e.g. according to input by a human.

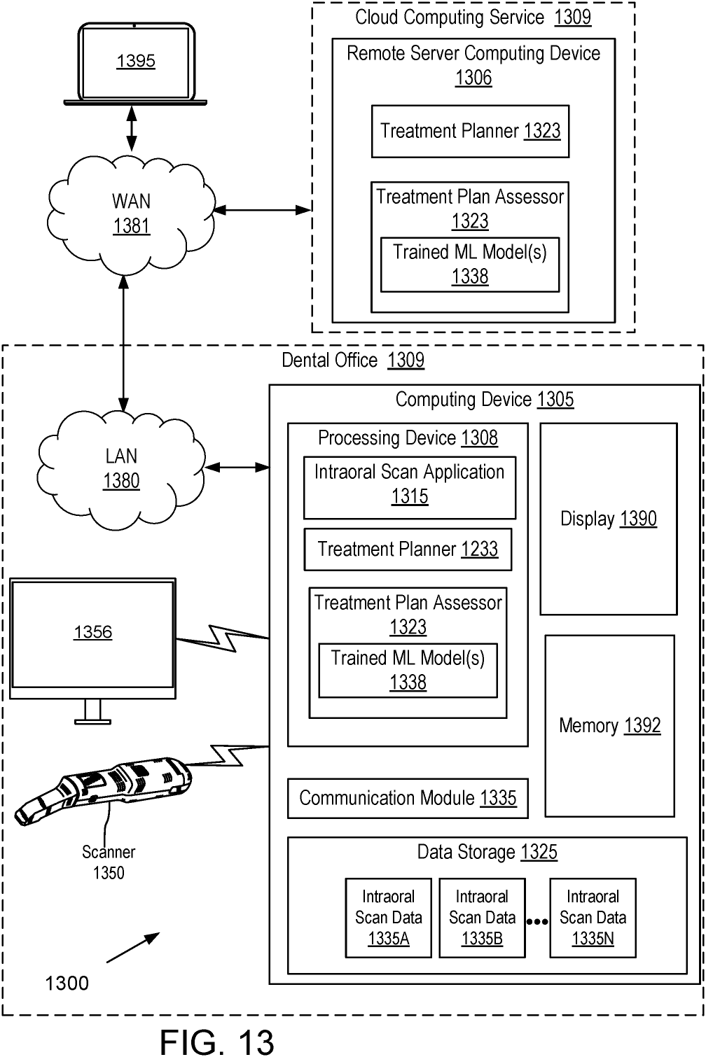

FIG. 13 illustrates an intraoral scanning and treatment planning system 1300, in accordance with an embodiment. System 1300 may include only components located at a single location (e.g., at a dentist office 1309 or a dental lab) in embodiments. Alternatively, system 1300 may include components located at multiple locations. The system 1300 may include an intraoral scanner (also referred to simply as a scanner) 1350 and a computing device 1305. In some embodiments, the system 1300 may additionally include, or take advantage of, a display 1356, a local area network (LAN) 1380, a remote server computing device 1306. Via the LAN 1380, the the computing device 1305 may connect to a wide area network (WAN) 1381, and through the WAN 1381 to remote server computing device 1306. The LAN 1380 may include a router, switch, bridge and/or other network device (not shown) that enables communication between multiple devices (e.g., computing device 1305 and scanner 1350) connected to the LAN 1380. The network device may provide wired connections to the LAN using, for example, Ethernet ports, universal serial bus (USB) ports and/or Firewire® ports. The network device may additionally provide wireless connections to the LAN using, for example, a Wi-Fi transceiver.

The WAN 1381 may include a public WAN (e.g., the Internet), a private WAN (e.g., an intranet), or a combination thereof. The WAN 1381 may include or connect to remote server computing device 1306. The server computing device 1306 may include a physical machine and/or a virtual machine hosted by a physical machine. The physical machine may be a rackmount server, a desktop computer, or other computing device. In one embodiment, the remote server computing device 1306 includes a virtual machine managed and provided by a cloud provider system or cloud computing service 1309. Each virtual machine offered by a cloud service provider may be hosted on a physical machine configured as part of a cloud. Such physical machines are often located in a data center. The cloud provider system and cloud may be provided as an infrastructure as a service (IaaS) layer. One example of such a cloud is Amazon’s® Elastic Compute Cloud (EC2®).

Computing device 1305 may include a processing device 1308, a communication module 1335, a memory 1392, and/or a data storage 1325. In some embodiments, memory 1392 and data storage 1325 are combined.

The processing device 1308 may be or include a microcontroller, a DSP, a PLC, a microprocessor or programmable logic device such as an FPGA or a CPLD. The processing device 1308 may additionally or alternatively include one or more special purpose processor and/or general purpose processor, such as a complex instruction set computing (CISC) microprocessor, reduced instruction set computing (RISC) microprocessor, very long instruction word (VLIW) microprocessor, processor implementing other instruction sets, or processor implementing a combination of instruction sets. Examples of special-purpose processing devices include an application specific integrated circuit (ASIC), a field programmable gate array (FPGA), a digital signal processor (DSP), and network processor. Processing device 1308 may be configured to execute an intraoral scan application 1315, a treatment planner 1233 and/or a treatment plan assessor 1323 in embodiments.

The memory may include a non-volatile memory (e.g., RAM) and/or a volatile memory (e.g., ROM, Flash, etc.). The data storage 1325 may include a local data store and/or a remote data store. The data storage 1325 may be or include secondary storage, such as a disc drive, a solid state drive, and so on. Computing device 1305 may additionally include a display 1390 and/or one or more additional processing device 1340 in some embodiments.

The communication module 1335 enables the computing device 1305 to connect to a LAN and/or directly to other devices such as scanner 1350. The communication module 1335 may be configured to manage security, manage sessions, manage communications with external devices, and so forth.

In some embodiments, computing device 1305 is a desktop computing device. In some embodiments, computing device 1305 is a laptop or notebook computing device. In some embodiments, computing device 1305 is a component of a cart used for intraoral scanning.

In some embodiments, computing device 1305 includes a display 1390. The display 1390 may be an integrated or attached display 1390. Computing device may alternatively or additionally be connected to a display 1356. Display 1390 and display 1356 may be, for example, a liquid crystal display (LCD), an organic light emitting diode (OLED) display, a cathode ray tube (CRT) display, or other type of display. Display 1356 may be, for example, a television (e.g., smart TVs), computer monitor, mobile device that includes a display (e.g., mobile phones, laptop computers, tablet computers, etc.), augmented reality (AR) headset, mixed reality (MR) headset, and so on. Some displays 1356 may be physically connected to the computing device 1305 via a wired connection. Some displays 1356 may be wirelessly connected to computing device 1305 via a wireless connection, which may be a direct wireless connection or a wireless connection via a wireless network. In embodiments, display 1356 is a smart display such as a smart television (TV). A smart TV may include an application installed thereon for communicating with and/or acting as a remote display for computing device 1305. Alternatively, or additionally, a smart TV may include a web browser, which may be used to navigate to a web page that streams data from computing device 1305. For example, the web page may stream a user interface of intraoral scan application 1315.

Intraoral scanner 1350 may include one or more light source, optics and one or more detectors for generating intraoral scan data (e.g., intraoral scans, color images, NIRI images, etc.), one or more buttons and/or touch sensitive inputs (e.g., touch pads and/or touchscreens), and so on. Intraoral scanner 1350 may additionally include a memory and/or a processing device (e.g., a controller) for performing initial processing on some or all of the intraoral scan data before it is transmitted to computing device 1305.

Intraoral scanner 1350 may generate intraoral scans, which may be or include color and/or monochrome 3D information, and send the intraoral scans to computing device 1305 via the wireless connection. In some embodiments, intraoral scans include height maps. Intraoral scanner 1350 may additionally or alternatively generate color two-dimensional (2D) images (e.g., viewfinder images), and send the color 2D images to computing device 1305 via the wireless connection. Scanner 1350 may additionally or alternatively generate 2D or 3D images under certain lighting conditions, such as under conditions of infrared or near-infrared (NIRI) light and/or ultraviolet light, and may send such 2D or 3D images to computing device 1305 via the wireless connection. Intraoral scans, color images, and images under specified lighting conditions (e.g., NIRI images, infrared images, ultraviolet images, etc.) are collectively referred to as intraoral scan data 1335A-N. An operator may start recording scans with the scanner 1350 at a first position in the oral cavity, move the scanner 1350 within the oral cavity to a second position while the scans are being taken, and then stop recording the scans. In some embodiments, recording may start automatically as the scanner 1350 identifies teeth and/or other objects.

A intraoral scan application 1315 running on processing device 1308 of computing device 1305 may communicate with the scanner 1350 via communication module 1335 to effectuate an intraoral scan. A result of the intraoral scan may be intraoral scan data 1335A, 1335B through 1335N that may include one or more sets of intraoral scans, one or more sets of viewfinder images (e.g., color 2D images showing a field of view of the intraoral scanner), one or more sets of NIRI images, and so on. Each intraoral scan may be a two-dimensional (2D) or 3D image that includes a height information (e.g., a height map) of a portion of a dental site, and thus may include x, y and z information. In one embodiment, each intraoral scan is a point cloud. In one embodiment, the intraoral scanner 1350 generates numerous discrete (i.e., individual) intraoral scans and/or additional images. In some embodiments, sets of discrete intraoral scans may be merged into a smaller set of blended intraoral scans, where each blended scan is a combination of multiple discrete intraoral scans.

In embodiments, scanner 1350 generates and sends to computing device 1305 a stream of intraoral scan data. The stream of intraoral scan data may include separate streams of intraoral scans, color images and/or NIRI images (and/or other images under specific lighting conditions) in some embodiments. In one embodiment, a stream of blended intraoral scans is sent to computing device 1305. In embodiments, the color 2D images in the stream are generated at a first frame rate. Computing device 1305 receives intraoral scan data from scanner 1350, then stores the intraoral scan data 1335A-N in data storage 1325.

According to an example, a user (e.g., a practitioner) may subject a patient to intraoral scanning. In doing so, the user may apply scanner 1350 to one or more patient intraoral locations. The scanning may be divided into one or more segments. As an example, the segments may include a lower dental arch of the patient, an upper dental arch of the patient, one or more preparation teeth of the patient (e.g., teeth of the patient to which a dental device such as a crown or other dental prosthetic will be applied), one or more teeth which are contacts of preparation teeth (e.g., teeth not themselves subject to a dental device but which are located next to one or more such teeth or which interface with one or more such teeth upon mouth closure), and/or patient bite (e.g., scanning performed with closure of the patient’s mouth with the scan being directed towards an interface area of the patient’s upper and lower teeth). Via such scanner application, the scanner 1350 may provide intraoral scan data 1335A-N to computing device 1305. The intraoral scan data 1335A-N may be provided in the form of intraoral scan/image data sets, each of which may include 2D intraoral scans/images and/or 3D intraoral scans/images of particular teeth and/or regions of an intraoral site. In one embodiment, separate scan/image data sets are created for the maxillary arch, for the mandibular arch, for a patient bite, and for each preparation tooth. Alternatively, a single large intraoral scan/image data set is generated (e.g., for a mandibular and/or maxillary arch). Such scans/images may be provided from the scanner to the computing device 1305 in the form of one or more points (e.g., one or more pixels and/or groups of pixels). For instance, the scanner 1350 may provide such a 3D scan/image as one or more point clouds.

The manner in which the oral cavity of a patient is to be scanned may depend on the procedure to be applied thereto. For example, if an upper or lower denture is to be created, then a full scan of the mandibular or maxillary edentulous arches may be performed. In contrast, if a bridge is to be created, then just a portion of a total arch may be scanned which includes an edentulous region, the neighboring preparation teeth (e.g., abutment teeth) and the opposing arch and dentition. Additionally, the manner in which the oral cavity is to be scanned may depend on a doctor’s scanning preferences and/or patient conditions.

By way of non-limiting example, dental procedures may be broadly divided into prosthodontic (restorative) and orthodontic procedures, and then further subdivided into specific forms of these procedures. Additionally, dental procedures may include identification and treatment of gum disease, sleep apnea, and intraoral conditions. The term prosthodontic procedure refers, inter alia, to any procedure involving the oral cavity and directed to the design, manufacture or installation of a dental prosthesis at a dental site within the oral cavity (intraoral site), or a real or virtual model thereof, or directed to the design and preparation of the intraoral site to receive such a prosthesis. A prosthesis may include any restoration such as crowns, veneers, inlays, onlays, implants and bridges, for example, and any other artificial partial or complete denture. The term orthodontic procedure refers, inter alia, to any procedure involving the oral cavity and directed to the design, manufacture or installation of orthodontic elements at a intraoral site within the oral cavity, or a real or virtual model thereof, or directed to the design and preparation of the intraoral site to receive such orthodontic elements. These elements may be appliances including but not limited to brackets and wires, retainers, clear aligners, or functional appliances.

During an intraoral scan session, intraoral scan application 1315 receives and processes intraoral scan data (e.g., intraoral scans) and generates a 3D surface of a scanned region of an oral cavity (e.g., of a dental site) based on such processing. To generate the 3D surface, intraoral scan application 1315 may register and “stitch” or merge together the intraoral scans generated from the intraoral scan session in real time or near-real time as the scanning is performed. In one embodiment, performing registration includes capturing 3D data of various points of a surface in multiple scans (views from a camera), and registering the scans by computing transformations between the scans. The 3D data may be projected into a 3D space for the transformations and stitching. The scans may be integrated into a common reference frame by applying appropriate transformations to points of each registered scan and projecting each scan into the 3D space.

In one embodiment, registration is performed for adjacent or overlapping intraoral scans (e.g., each successive frame of an intraoral video). In one embodiment, registration is performed using blended scans and/or reduced or cropped scans. Registration algorithms are carried out to register two or more adjacent intraoral scans and/or to register an intraoral scan with an already generated 3D surface, which essentially involves determination of the transformations which align one scan with the other scan and/or with the 3D surface. Registration may involve identifying multiple points in each scan (e.g., point clouds) of an scan pair (or of a scan and the 3D model), surface fitting to the points, and using local searches around points to match points of the two scan (or of the scan and the 3D surface). For example, intraoral scan application 1315 may match points of one scan with the closest points interpolated on the surface of another image, and iteratively minimize the distance between matched points. Other registration techniques may also be used. Intraoral scan application 1315 may repeat registration and stitching for all scans of a sequence of intraoral scans and update the 3D surface as the scans are received.

A user (e.g., a practitioner) may navigate through scanning segments (e.g., an upper dental arch segment, a lower dental arch segment, a bite segment, and optionally a separate segment for each preparation tooth) via a user interface (UI) of the intraoral scan application 1315 by various input devices, such as a cursor control device (e.g., a mouse), a remote control (e.g., of a smart TV), a touch input device (e.g., touchscreen) of a scanner 1350, etc. Navigation or control of the user interface of the intraoral scan application 1315 may be performed via user input. The user input may be performed through various devices, such as a touch input device (e.g., a touchscreen), keyboard, mouse, or other similar control devices of one or more device wirelessly connected to computing device 1305. User input may also be provided via scanner 1350 in embodiments, such as via a touchpad and/or touchscreen of the intraoral scanner 1350. Navigation of the user interface may involve, for example, navigating between various modules or modes, navigating between various segments, controlling the viewing of the 3D rendering, or any other user interface navigation.

When a scan session is complete (e.g., all scans for an intraoral site or dental site have been captured), a treatment planner 1323 may process intraoral scan data 1335A-N to generate a treatment plan. Additionally, or alternatively, computing device 1305 may send the intraoral scan data (e.g., including at a minimum intraoral scans) to remote server computing device 1306 for processing by treatment planner 1323 and/or treatment plan assessor 1338.

Treatment planner 1323 may include a model generator that may process the intraoral scan data to generate one or more virtual 3D model of a patient’s dental arch or dental arches (e.g., of an initial arrangement of a patient’s teeth). The model generator may generate a virtual 3D model (also referred to as a digital 3D model) of one or more scanned dental sites. The virtual 3D model includes a 3D surface of the one more scanned dental sites (e.g., of the initial arrangement of the patient’s teeth or dentition). To generate the virtual 3D model, the model generator may register and “stitch” or merge together the intraoral scans generated from the intraoral scan session. In one embodiment, registration is performed for adjacent and/or overlapping intraoral scans (e.g., each successive frame of an intraoral video). In one embodiment, registration is performed using blended scans and/or reduced or cropped scans. Registration algorithms may be carried out to register two or more adjacent intraoral scans and/or to register an intraoral scan with a 3D model, which essentially involves determination of the transformations which align one scan with the other scan and/or with the 3D model. Registration may involve identifying multiple points in each scan (e.g., point clouds) of a scan pair (or of a scan and the 3D model), surface fitting to the points, and using local searches around points to match points of the two scans (or of the scan and the 3D model). For example, the model generator may match points of one scan with the closest points interpolated on the surface of another scan, and iteratively minimize the distance between matched points. Other registration techniques may also be used. The registration and stitching that are performed to generate the 3D model may be more accurate than the registration and stitching that are performed to generate the 3D surface that is shown in real time or near-real time during the scanning process.

The model generator may repeat registration for all scans of a sequence of intraoral scans to obtain transformations for each scan, to register each scan with the previous one and/or with a common reference frame (e.g., with the 3D model). The model generator may integrate all scans (or all scans associated with a segment) into a single virtual 3D model by applying the appropriate determined transformations to each of the scans. Each transformation may include rotations about one to three axes and translations within one to three planes. In some embodiments, a first model of an upper dental arch and a second model of a lower dental arch are generated.

A user (e.g., a dentist) may access and view the virtual 3D model(s) by accessing a user interface of treatment planner 1323 from a client computing device 1395. Alternatively, a user may access and view the virtual 3D models by interfacing with computing device 1305. The client computing device 1395 may be any computing device, such as a tablet computer, a desktop computer, a mobile phone, a laptop, a notebook computer, and so on.

A user interface of treatment planner 1323 may generate a view of the 3D model and output the view to client computing device 1395 for display of the 3D model to a user (e.g., a doctor) via a display of the client computing device 1395. A doctor may then interface with the client computing device 1395 or computing device 1305 to generate commands to change the view of the 3D model (e.g., by zooming in or out, panning, rotating, etc.). The client computing device 1395 may send the command to remote intraoral scan application 1316, which may change the view of the 3D model, and then send the updated view to the client computing device 1395. Alternatively, a user may provide commands to computing device 1305 for changing a view of a 3D model. In this manner, the 3D model can be checked visually by the doctor. The doctor can virtually manipulate the 3D model via the user interface of the client computing device 1395 or computing device 1305 with respect to up to six degrees of freedom (i.e., translated and/or rotated with respect to one or more of three mutually orthogonal axes) using suitable user controls (hardware and/or virtual) to enable viewing of the 3D model from any desired direction. The doctor may review (e.g., visually inspect) the generated 3D model of an intraoral site and determine whether the 3D model is acceptable (e.g., whether a margin line of a preparation tooth is accurately represented in the 3D model).

In one embodiment, treatment planner 1323 is configured to perform treatment planning for orthodontic treatment and/or prosthodontic treatment. The treatment planner 1323 in embodiments generates an orthodontic treatment plan, including a 3D model for a final tooth arrangement and 3D models for one or more intermediate tooth arrangements. A doctor may control the treatment planner 1323 and navigate menus and options of the treatment planner using the client computing device 1395, computing device 1305 and/or scanner 1350.

In one embodiment, treatment plan assessor 1323 performs outlier detection on a treatment plan, as described herein above. The treatment plan assessor 1323 may apply one or more trained machine learning models, each of which may output an indication as to whether a treatment plan may be problematic (e.g., may impose a clinical risk to a patient). Such assessment may include assessment of a final arrangement of a patient’s teeth (e.g., associated with a final post-treatment 3D model of the patient’s upper and/or lower dental arches). If the treatment plan is determined to impose a clinical risk or otherwise be problematic (e.g., be classified as including an outlier final arrangement of the patient’s teeth), then treatment plan assessor 1323 may flag the treatment plan for inspection by a technician or other professional. In some embodiments, processing logic highlights one or more anomalies or other areas of interest (AOIs) in the final post-treatment 3D model that contributed to the treatment plan as being flagged as potentially problematic. In one embodiment, a new treatment plan is automatically generated responsive to a treatment plan being classified as having an outlier final arrangement of a patient’s teeth or otherwise being classified as potentially problematic. The new treatment plan may have a second final arrangement of the patient’s teeth that is different from a first final arrangement of the patient’s teeth associated with the initial treatment plan. Via a user interface, a practitioner may perform inspection of a 3D model of the final post-treatment arrangement of the patient’s teeth. This may include the practitioner rotating, zooming in, zooming out, panning, etc. the 3D model. Via such inspection the practitioner may confirm that the final arrangement of the patient’s teeth are problematic or that the final arrangement of the patient’s teeth is acceptable. If the practitioner determines that the final arrangement of the patient’s teeth is problematic, then a new treatment plan including an alternative final arrangement of the patient’s teeth may be generated.

Once the final arrangement of the patient’s teeth is confirmed as being acceptable and an adequate set of 3D models is generated, the 3D models may be saved to a patient profile. The dental practitioner may then navigate to a delivery mode to electronically send the completed patient profile to a processing center. The processing center may then generate the custom made series of clear aligners for the patient and deliver the clear aligners to the dental practitioner. The patient would then return to the dental practitioner to receive the first set of clear aligners and verify the clear aligners properly fit onto the patient’s teeth.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of the systems described in FIG. 4 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of systems described in FIG. 4 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of the systems described in FIG. 4 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of the systems described in FIG. 4 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of the systems described in FIG. 4 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of the systems described in FIG. 4 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

It will be understood that although the terms “first,” “second,” “third”, etc. may be used herein to describe various layers, elements, components, regions or sections without referring to any particular order or sequence of events. These terms are merely used to distinguish one layer, element, component, region or section from another layer, element, component, region or section. A first layer, element, component, region or section as described herein could be referred to as a second layer, element, component, region or section without departing from the teachings of the present disclosure.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

What is claimed is:

1. A method for orthodontically treating a patient’s teeth, the method comprising:
receiving an initial three-dimensional (3D) model of an initial arrangement of a patient’s teeth;
generating a first final 3D model of a first final arrangement of the patient’s teeth based on the initial 3D model of the initial arrangement of the patient’s teeth;
comparing the first final arrangement of the patient’s teeth with a set of a plurality of final arrangements of teeth from previous treatment plans of past patients;
determining whether the first final arrangement of the patient’s teeth satisfies one or more outlier criteria based on the comparing; and
responsive to determining that the first final arrangement of the patient’s teeth satisfies the one or more outlier criteria, classifying an orthodontic treatment plan comprising the first final 3D model of the first final arrangement of the patient’s teeth as a clinical risk and generating a second final 3D model of a second final arrangement of the patient’s teeth.

2. The method of claim 1, further comprising:
generating the orthodontic treatment plan comprising tooth movement paths to move the patient’s teeth from the initial arrangement towards the first final arrangement in a series of tooth movement stages.

3. The method of claim 2, further comprising:
responsive to determining that the first final arrangement of the patient’s teeth fail to satisfy the one or more outlier criteria, fabricating a series of dental appliances based on the orthodontic treatment plan and including at least one conversion appliance for a conversion appliance stage and a plurality of appliances for the series of tooth movement stages.

4. The method of claim 1, further comprising:
generating a set of parameters based on the first final arrangement of the patient’s teeth.

5. The method of claim 4, wherein the set of parameters describe three-dimensional characteristics of the first final arrangement of the patient’s teeth.

6. The method of claim 5, wherein the set of parameters include at least one of inclination, rotation, angulation, or prominence for each tooth of the first final arrangement of the patient’s teeth.

7. The method of claim 6, wherein the set of parameters include at least one of inclination-by-axes, angulation-by-axes, rotation-by-axes, whether or not a tooth is extracted, or a space between adjacent teeth for each tooth of the first final arrangement of the patient’s teeth.

8. The method of claim 1, further comprising:
electing the set of the plurally of final arrangements of the teeth based on a geographic region of the past patients and an age of the past patients.

9. The method of claim 1, wherein comparing the first final arrangement of the patient’s teeth with the set of a plurality of final arrangements of teeth from the previous treatment plans of past patients includes:
determining a cluster based local outlier factor for the first final arrangement of the patient’s teeth with respect to the plurality of final arrangements of teeth from the previous treatment plans of the past patients.

10. The method of claim 9, wherein determining whether the first final arrangement of the patient’s teeth satisfies the one or more outlier criteria comprises comparing the cluster based local outlier factor for the first final arrangement of the patient’s teeth to one or more thresholds related to deviation between the first final arrangement of the patient’s teeth and the plurality of final arrangements of teeth from the previous treatment plans.

11. The method of claim 9, further comprising:
generating clusters based on the plurality of final arrangements of teeth from the previous treatment plans of the past patients; and
identifying the cluster based local outlier factor for the first final arrangement of the patient’s teeth based on the clusters, wherein the one or more outlier criteria comprise a local outlier factor threshold.

12. The method of claim 1, wherein comparing the first final arrangement of the patient’s teeth with the set of the plurality of final arrangements of teeth from the previous treatment plans of the past patients includes:
determining an average k-nearest neighbor (k-NN) using a k-nearest neighbors algorithm for the first final arrangement of the patient’s teeth with respect to the plurality of final arrangements of teeth from the previous treatment plans of the past patients.

13. The method of claim 12, wherein determining whether the first final arrangement of the patient’s teeth satisfies the one or more outlier criteria comprises comparing the average k-NN for the first final arrangement of the patient’s teeth to a threshold.

14. The method of claim 12, further comprising training the k-nearest neighbors algorithm by generating feature vectors and class labels based on the plurality of final arrangements of teeth from the previous treatment plans of the past patients.

15. The method of claim 1, wherein comparing the first final arrangement of the patient’s teeth with the set of the plurality of final arrangements of teeth from the previous treatment plans of the past patients includes:
determining a path length in one or more isolation trees of an isolation forest for the first final arrangement of the patient’s teeth based on isolation trees generated based on the plurality of final arrangements of teeth from the previous treatment plans of the past patients.

16. The method of claim 15, wherein determining whether the first final arrangement of the patient’s teeth satisfies the one or more outlier criteria comprises comparing the path length the first final arrangement of the patient’s teeth to a threshold.

17. The method of claim 15, further comprising:
generating the isolation trees based on the plurality of final arrangements of teeth from the previous treatment plans of the past patients.

18. The method of claim 1, wherein the comparing includes comparing based on application of two or more outlier detection methods including:
determining an average k-nearest neighbor (k-NN) using a k-nearest neighbors algorithm for the first final arrangement of the patient’s teeth with respect to the plurality of final arrangements of teeth from the previous treatment plans of the past patients,
determining a cluster based local outlier factor for the first final arrangement of the patient’s teeth with respect to the plurality of final arrangements of teeth from the previous treatment plans of the past patients, and
determining a path length in one or more isolation trees of an isolation forest for the first final arrangement of the patient’s teeth based on isolation trees generated based on the plurality of final arrangements of teeth from the previous treatment plans of the past patients.

19. The method of claim 18, wherein the determining whether the first final arrangement of the patient’s teeth satisfies the one or more outlier criteria comprises determining that a majority of the two or more outlier detection methods indicate that the first final arrangement of the patient’s teeth is an outlier.

20. A system comprising:
a processor; and
a memory including instructions that when executed by the processor cause the system to perform operations comprising:
receiving an initial three-dimensional (3D) model of an initial arrangement of a patient’s teeth;
generating a first final 3D model of a first final arrangement of the patient’s teeth based on the initial 3D model of the initial arrangement of the patient’s teeth;
comparing the first final arrangement of the patient’s teeth with a set of a plurality of final arrangements of teeth from previous treatment plans of past patients;
determining whether the first final arrangement of the patient’s teeth satisfies one or more outlier criteria based on the comparing; and
responsive to determining that the first final arrangement of the patient’s teeth satisfies the one or more outlier criteria, classifying an orthodontic treatment plan comprising the first final 3D model of the first final arrangement of the patient’s teeth as a clinical risk.

21. A method comprising:
identifying an anticipated result of a treatment plan before implementing the treatment plan;
comparing the anticipated result of the treatment plan to one or more known results of one or more performed treatment plans;
identifying whether the anticipated result of the treatment plan is an outlier result in comparison to the one or more known results of the one or more performed treatment plans by comparing treatment plan-specific factors associated with the anticipated result and the one or more known results; and
facilitating review of the treatment plan based on whether the anticipated result of the treatment plan is an outlier result in comparison to the one or more known results.

22. The method of claim 21, wherein the treatment plan and the performed treatment plans include digital treatment plans for treating one or more patients.

23. The method of claim 21, wherein the treatment plan-specific factors associated with the anticipated result and the one or more known results include characteristics of the anticipated result and the one or more known results.

24. The method of claim 23, wherein the treatment plan-specific factors associated with the anticipated result and the one or more known results include features in differences between the characteristics of the anticipated result and the one or more known results.

25. The method of claim 21, further comprising determining whether the anticipated result of the treatment plan is the outlier result based on deviation between the treatment plan-specific factors associated with the anticipated result and the treatment plan-specific factors associated with the one or more known results.

26. The method of claim 25, further comprising:
applying a plurality of different outlier detection techniques to determine various degrees of deviation between the treatment plan-specific factors associated with the anticipated result and the treatment plan-specific factors associated with the one or more known results; and
determining that the anticipated result of the treatment plan is the outlier result responsive to determining that more than one of the different outlier detection techniques indicate that the anticipated result of the treatment plan is the outlier result based on the deviation between the treatment plan-specific factors associated with the anticipated result and the treatment plan-specific factors associated with the one or more known results.

27. The method of claim 26, wherein the plurality of different outlier detection techniques include machine learning techniques for grouping values of the treatment plan-specific factors associated with the anticipated result and the one or more known results amongst the treatment plan-specific factors across the anticipated result and the one or more known results.

28. The method of claim 25, wherein the treatment plan-specific factors associated with the anticipated result are identified by simulating the treatment plan without actually performing the treatment plan in its entirety.

29. The method of claim 21, further comprising facilitating modification of the treatment plan based on whether the anticipated result of the treatment plan is the outlier result in comparison to the one or more known results.
